(19) United States
(12) Patent Application Publication
(10) Pub. No.: US 2025/0108833 A1
(43) Pub. Date: Apr. 3, 2025

(54) AUTONOMOUS DRIVING USING PREDICTIONS OF TRUST

(71) Applicant: Honda Motor Co., Ltd., Tokyo (JP)

(72) Inventors: Minxue NIU, Ann Arbor, MI (US); Zhaobo K. ZHENG, Campbell, CA (US); Kumar AKASH, San Jose, CA (US); Teruhisa MISU, San Jose, CA (US)

(21) Appl. No.: 18/479,984

(22) Filed: Oct. 3, 2023

(51) Int. Cl. B60W 60/00; B60W 40/08

(52) U.S. Cl. CPC B60W 60/0013; B60W 40/08; B60W 2540/22; B60W 2540/225; B60W 2556/00

(57) ABSTRACT

A method and system for modeling trust levels of drivers and modifying autonomous systems in real time in response to predicted trust levels. These modifications may be made by one or more systems, including an autonomous driving agent. An end-to-end attention network known as a Selective Windowing Attention Network (SWAN) learns directly from time-series data and assigns attention to critical areas.

### BACKGROUND

Autonomous vehicles (AV) and related autonomous driver-assistance systems (ADAS) are increasingly used.

Trust in autonomous vehicle (AV) and advanced driver assistance systems (ADAS) may change the extent to which autonomous vehicles are used. Improved trust may lead to increased use of AV or ADAS systems and may reduce driver anxiety. Understanding the level of trust a user has in AV and/or ADAS systems is also relevant in determining how the AV and/or ADAS systems will operate (for example, the systems' ‘driving style’). Predicting internal mental states of a driver, such as trust, is therefore an important part of increasing AV and ADAS use and in controlling how those systems operate in real time. Determining the level of trust a driver may have in an autonomous system presents several challenges including accurately modeling trust from measurable data, and avoiding frustrating the driver in the data collection process.

There is a need in the art for a system and method that addresses the shortcomings discussed above.

### SUMMARY

Embodiments provide herein disclose methods and systems for predicting driver trust in autonomous systems of a vehicle and taking actions in response to the predicted trust.

In some aspects, the techniques described herein relate to an autonomous driving agent for a vehicle, including: circuitry coupled to one or more sensors of the vehicle, wherein the circuitry is configured to: receive input data from the one or more sensors, the input data including occupant sensor data associated with an occupant of an autonomous vehicle and the input data including vehicle sensor data associated with the operation of the autonomous vehicle; determine, from the input data, a trust value indicating a level of trust of a human in the autonomous driving agent using a neural network; and automatically modify control of one or more vehicle systems of the vehicle according to the determined trust value.

In some aspects, the techniques described herein relate to a system, including: one or more processors; memory storing instructions that when executed by the one or more processors cause the one or more processors to: receive input data, the input data including occupant sensor data associated with an occupant of an autonomous vehicle and the input data including vehicle sensor data associated with the operation of the autonomous vehicle; provide the input data to a neural network; and generate a trust value using the neural network.

In some aspects, the techniques described herein relate to a computer-implemented method, including: receiving input data, the input data including occupant sensor data associated with an occupant of an autonomous vehicle and the input data including vehicle sensor data associated with the operation of the autonomous vehicle; providing the input data to a neural network; and generating a trust value from the neural network.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

### BRIEF DESCRIPTION OF THE DRAWINGS

The embodiments may be better understood with reference to the following drawings and description. The components in the figures are not necessarily to scale, emphasis instead being placed upon illustrating the principles of the embodiments. Moreover, in the figures, like reference numerals designate corresponding parts throughout the different views.

FIG. 1 is a schematic view of a process for predicting driver trust in an AV and/or ADAS system and for using the predicted information to automatically modify control of one or more vehicle systems, according to an embodiment.

FIG. 2 is a schematic view of an architecture for a system that uses real-time trust prediction to automatically adjust one or more vehicle systems, according to an embodiment.

FIG. 3 is a schematic view of an architecture for an autonomous driving agent and an associated remote system, according to an embodiment.

FIG. 4 is a schematic view of an exemplary architecture for a neural network model, according to one embodiment.

FIG. 5 is a schematic view of several images representing scenes from a driving sequence and corresponding window weightings visualized for the same time period, according to an embodiment.

FIG. 6 is a schematic plot comparing the performance of a neural network model and a Random Forest model across different window sizes.

FIG. 7 is a schematic view of several transformations associated with a neural network model, according to an embodiment.

### DETAILED DESCRIPTION

Embodiments provide herein disclose methods and systems for autonomous driving. The methods and systems include provisions to model trust levels of drivers and modify autonomous systems in real time in response to predicted trust levels. These modifications may be made by one or more systems, including an autonomous driving agent.

Methods for predicting trust may use sensed data and machine learning models to predict driver states based on the sensed data. A challenge in predicting trust from machine learning models is the difficulty in learning useful information from long time-series input and sparse training data. For example, user trust in an AV or ADAS system may be relatively stable over long periods of time, but may change rapidly during critical time periods in response to particular events. A challenge for any models predicting trust from long time series is to identify these critical time periods from long, noisy time-series input.

Windowing is a technique employed in analysis of time series data so that models may learn from the most pertinent segments of the data. However, systems employing windowing may require extensive testing to find an optimal window length for each feature in a model. Moreover, the optimal window length may depend on various factors including feature type, individual responses and contextual information, requiring extensive domain expertise and time to search for optimal window sizes.

In other words, modeling trust using machine learning models presents technical challenges, including the problem of determining appropriate window sizes when employing windowing techniques to time series data.

The embodiments provide systems and methods that solve these technical challenges by utilizing a novel neural network architecture that automates the process of windowing time series data while enabling flexible-length attended area selection through gradient-based optimization. The resulting systems provide an end-to-end attention network known as a Selective Windowing Attention Network (SWAN) that learns directly from time-series data and assigns attention to critical areas. Specifically, the embodiments provide systems and methods for modeling a prolonged driver state (namely, “trust”) based on multi-modal time series signals.

Moreover, the systems and methods of the embodiments leverage trust predictions made using the exemplary neural network to automatically implement one or more corrective actions to AV and/or ADAS systems during driving, as discussed in further detail below.

Moreover, the exemplary systems provide a non-intrusive interface which is touchless for gathering relevant input data.

The exemplary system is also more computationally efficient than alternative systems that require richer data, as the exemplary systems only require processing easily accessible vehicle telemetry data and minimal data from an occupant, including gaze information.

The embodiments include methods to modify autonomous systems associated with one or more vehicles. As used herein, the term “vehicle” refers to any cars, trucks, vans, minivans, SUVs, motorcycles, scooters, boats, watercraft, and aircraft. Vehicles may further comprise any kind of gasoline powered vehicles, hybrid vehicles, electric vehicles, or other vehicles utilizing other suitable kinds of energy sources. Moreover, autonomous vehicles may include any of these types of vehicles, and autonomous driver assistance systems may be used with any of these types of vehicles.

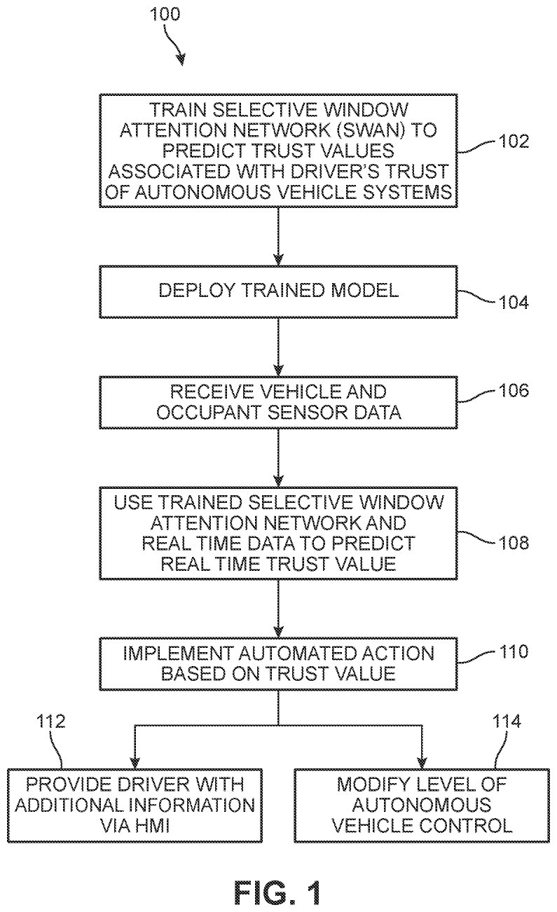

FIG. 1 is a schematic view of a process 100 for predicting driver trust in an AV and/or ADAS system and for using the predicted information to automatically modify control of one or more vehicle systems. It may be appreciated that one or more blocks of process 100 may be performed by one or more systems onboard (or otherwise in communication with) a vehicle. In some embodiments, one or more of the following blocks may be performed by an autonomous driving agent.

Starting in block 102, a Selective Window Attention Network may be trained to predict trust values (also referred to as trust scores or trust levels). Here, the term “trust value” (also, “trust score” or “trust level”) refers to any suitable numerical or categorical value indicating the degree to which a driver (or other occupant of a vehicle) trusts an AV, ADAS, or other autonomous vehicle system. In some embodiments, trust may be given as a value within a numerical range. In other cases, trust may be given by one or more categorical variables (such as ‘low trust’, ‘moderate trust’, and ‘high trust’). In some cases, a trust value may have one of two possible values, either numerical or categorical, which represent a high trust value and a low trust value.

Once the network has been trained using suitable training data, the trained model may be deployed, as in block 104. In some cases, the deployed model may be stored and executed on a system inside a vehicle. In other cases, the deployed model may be stored and executed on a remote system, and real time data may be provided as input to the deployed model over a suitable wireless network. In some cases, the deployed model may be stored in local memory within a vehicle computer system and retrieved and executed by an autonomous driving agent.

In block 106, as a vehicle is driving, vehicle data and occupant sensor data may be retrieved from relevant sensors in real time. In some cases, the data may be retrieved by an autonomous driving agent. Here, “vehicle data” refers to data indicating a state of the vehicle itself, including one or more dynamic states. Vehicle data may also refer to data related to one or more systems operating within a vehicle. Exemplary types of vehicle data may include velocity data, angular velocity data, steering angle data, navigation direction data, and engine sound volume data. In some cases, vehicle data may also include information about real-time proactive voice data (such as the on/off state of such a proactive voice in the vehicle), which may be associated with an autonomous vehicle system that provides real-time audible feedback to drivers and other occupants.

By contrast with vehicle data, “occupant data” refers to data indicative of a state of an occupant, such as the driver. Occupant data may include, for example, gaze signals that detect where an occupant is looking, as well as the pupil diameters of each eye. Detecting where an occupant is looking may comprise determining a direction relative to a suitable reference frame, and/or determining a location where the gaze falls on a reference surface. In some cases, the reference surface may be a windshield or a display.

In some cases, gaze signals may further include information about the types of objects that an occupant's gaze falls on, such as a tree, a pedestrian, or a roadway. In other embodiments, occupant data may include other types of physiological data such as heart rate, skin conductance, breathing rate, and other suitable data. Gaze data may serve as a proxy for the type of visual information being obtained by an occupant as they are in the vehicle, which may be further indicative of their current mental state (including level of trust in the autonomous driver of the vehicle).

Embodiments are not limited to vehicle data and occupant data, but may include other data as well. In some embodiments, one or more types of metadata may be retrieved along with vehicle and/or occupant data. Exemplary types of metadata may include the observed form of autonomous mobility (for example, if the autonomous vehicle is a car driving on the street or a scooter driving on a sidewalk), the driving style, and the presence of proactive prompts.

In block 108, the data received in block 106 may be provided as inputs to the trained network (the SWAN). In some cases, this block is performed by an autonomous driving agent that has already retrieved the necessary data and also has access to the trained network. The data is then processed by the network, which generates trust data in real time as outputs.

In block 110, one or more automated actions may be implemented based on real-time trust values predicted by the network. In some cases, the one or more actions may be implemented by an autonomous driving agent. If the trust values are binary, actions may be taken based solely on the predicted values. If the trust values have more than two possible values, indicating a range of trust, the system may use suitable thresholds (including ranges of thresholds) to make decisions.

Block 112 and block 114 provide two optional processes that may be taken based on trust values and/or changes in trust values. In block 112, upon detecting that trust has decreased the system may automatically provide the driver with additional information via a Human Machine Interface (HMI), which is described in further detail below. For example, a system may automatically highlight objects in the drivers view (for example, using a separate display screen, or using a heads-up display on the windshield) to indicate that the system is aware of potential obstacles to be avoided (such as trees and pedestrians). Such an action may have a calming effect on a driver and may help reestablish trust with one or more autonomous systems.

In block 114, upon detecting that the trust level has changed, a system may automatically modify the level of autonomous control of a vehicle. In particular, as trust decreases, the level of autonomous control may decrease. As the level of trust increases, the level of autonomous control may increase.

The actions associated with block 112 and block 114 are only intended to be exemplary, and embodiments may take any suitable actions related to modifying HMI systems and/or autonomous control systems. The embodiments may utilize any of the intervening actions, systems and methods, related to modifying one or more vehicle systems, including both HMI systems and autonomous vehicle systems, which are disclosed in U.S. Patent Number______, currently U.S. Patent Publication Number 2022/0396287, to Akash et al., filed Jun. 10, 2021, titled “Adaptive Trust Calibration”; in U.S. Pat. No. 11,332,165, to Akash et al., issued Jan. 27, 2020, and titled “Human Trust Calibration for Autonomous Driving Agent of Vehicle,”; and in U.S. Patent Number______, currently U.S. Patent Publication Number 2022/0324490, to Akash et al., filed Sep. 3, 2021, and titled “System and Method for Providing an RNN-Based Human Trust Model,” the entirety of each of these publications being herein incorporated by reference. For convenience, these publications are referred to collectively as the “Trust Calibration References”.

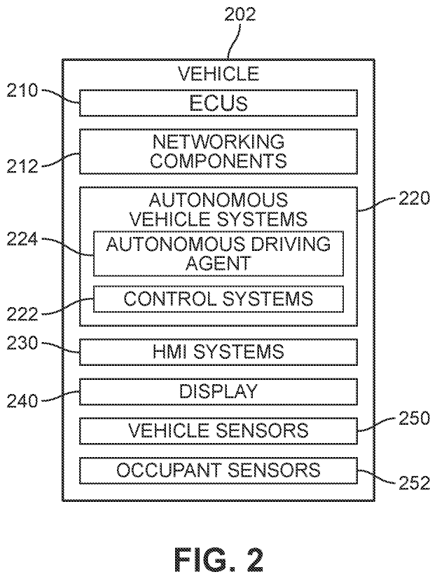

FIG. 2 is a schematic view of an architecture for a system that uses real-time trust prediction to automatically adjust one or more vehicle systems. Referring to FIG. 2, the architecture includes a vehicle 202. Vehicle 202 further includes one or more electronic control units 210 (ECUs 210) and networking components 212. ECUs 210 may comprise one or more discrete computing systems that may each include one or more processors, as well as non-transitory computer-readable media (memory) for storing instructions that may be executed by the one or more processors.

Networking components 212 may comprise one or more suitable devices, chips, cards, or other systems for communicating over wired and/or wireless networks. Suitable networking components may include a Wi-Fi card, a cellular network card, a Personal Area Network (PAN) card, a Near Field Communication (NFC) chip as well as other suitable components to facilitate wireless communication between systems of a vehicle and other systems.

Vehicle 202 may further include human machine interface (HMI) systems 230. HMI systems 230 include any suitable systems for providing an interface between a human driver and a machine. Relevant HMI devices may include speakers, audio devices, a display (screen), a heads-up display, a dashboard display, as well as other suitable interfaces. HMI systems 230 may generate and implement one or more HMI actions, such as displaying a cue, displaying an alert, providing an audio cue or audio alert, or providing haptic cues. Embodiments may utilize any of the specific HMI systems and methods disclosed in the Trust Calibration References.

Vehicle 202 may further include a display 240. Display 240 may be a screen, a heads-up display, or any other suitable display. In some cases, vehicle 202 includes more than one type of display.

Vehicle 202 may also include one or more sensors for sensing vehicle data, occupant data, or other suitable kinds of data. For example, vehicle 202 may include vehicle sensors 250. Vehicle sensors 250 may include cameras, LIDAR sensors, Radar sensors, lasers, steering angle sensors, braking sensors, velocity sensors, wheel speed sensors, acceleration sensors, accelerometers, gyroscopes, GPS sensors, microphones, as well as other suitable sensors for detecting various kinds of vehicle data, including telemetry data. In some cases, vehicle sensor data may be available to one or more systems of vehicle 202 via a controller area network (CAN bus) which further communicates with an onboard diagnostics (OBD) system of the vehicle.

Vehicle 202 may also include occupant sensors 252, such as cameras, LIDAR sensors, Radar sensors, lasers, physiological sensors (such as heart rate sensors), and other suitable sensors. Exemplary embodiments may include components for detecting gaze signals for a driver. The embodiments may utilize any of the specific sensors and detection systems for gaze detection as described in the Trust Calibration References. In other embodiments, occupant sensors 252 may include sensors associated with user-worn devices, such as smart watches, which may provide various kinds of physiological data.

Vehicle 202 may be associated with one or more autonomous vehicle systems. Autonomous vehicle systems 220 may comprise both systems for directly controlling a vehicle as well as autonomous driver assistance systems. For example, autonomous vehicle systems 220 may include control systems 222 that facilitate autonomous driving. Exemplary control systems may include drive-by-wire systems, specifically throttle by wire, brake by wire, shift by wire, steer by wire, and other electrical control systems to facilitate autonomous driving.

In some embodiments, autonomous vehicle systems 220 may make use of suitable onboard technologies and sensors to autonomously drive vehicle 202 from one location to another. These may include adaptive cruise control, anti-lock brake systems, active steering, as well as suitable sensors such as Light Detection and Ranging (LIDAR) sensors and radar systems. Autonomous vehicle control systems 202 may also use Global Positioning System (GPS) or Global Navigation Satellite System (GNSS) navigation technology.

Autonomous vehicle systems 220 may also include an autonomous driving agent 224. Autonomous driving agent 224 may comprise processors, circuitry, memory, and software for implementing autonomous driving. In particular, autonomous driving agent 224 may make take in information from one or more sensors, make autonomous decisions, and implement automated driving controls via drive-by-wire or other autonomous vehicle systems 220.

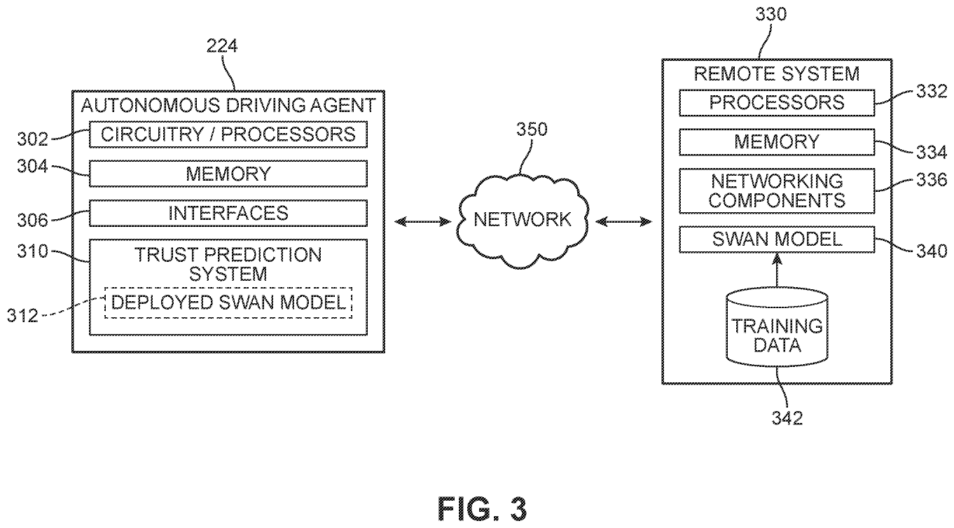

FIG. 3 is a schematic view including a detailed view of an autonomous driving agent that may communicate with a remote system. Referring to FIG. 3, autonomous driving agent 224 may include circuitry and/or processors 302, memory 304 and interfaces 306. Interfaces 306 may include I/O interfaces for communicating with sensors and/or control systems onboard the vehicle. Interfaces 306 may also include network interfaces.

Autonomous driving agent 224 may be responsible for determining a trust level of a driver and taking automated actions in response to determining trust levels. To estimate trust levels, autonomous driving agent 224 may further include a trust prediction system 310. Trust prediction system 310 includes one or more modules for detecting real-time data and predicting trust values indicative of a driver's current level of trust for one or more autonomous vehicle systems. Trust prediction system 310 may also include provisions (modules or logic, for example) for instructing one or more vehicle systems to take actions in response to trust levels (including changes in trust levels).

As described above, the embodiments may use a Selective Window Attention Network (SWAN) to predict driver trust in autonomous vehicle systems. In some embodiments, some components of the SWAN may be implemented within vehicle 202, while other components may be implemented on or more remote computing systems. In an exemplary architecture, a deployed (trained) SWAN model 312 is incorporated within trust prediction system 310, which may be stored and executed on devices (such as one or more ECUs) within vehicle 202.

In some cases, to manage computing resources, the SWAN model may be separately developed and trained on a remote system 330. Remote system 330 may comprise processors 332 as well as memory 334 for storing instructions executable by processors 332. Remote system 330 may also include networking components 336. Specifically, networking components 336 may include any of the networking components described above for networking components 336. Moreover, systems of vehicle 202 (including autonomous driving agent 224) and remote system 330 may communicate via these corresponding networking components, for example, over a wide area network 350.

Remote system 330 may be used to construct, store, and train SWAN model 340. In some cases, remote system 330 also stores training data 342 that is used for training model 340.

In some embodiments, SWAN model 340 may be trained, and then a deployed model may be run to predict real time trust values from sensed data. In the exemplary embodiment, deployed SWAN model 312 may be implemented onboard vehicle 202 as part of a trust prediction system 310. In other cases, a deployed model may be maintained at remote system 330 and input data may be passed from sensors onboard vehicle 202 to remote system 330 via wide area network 350.

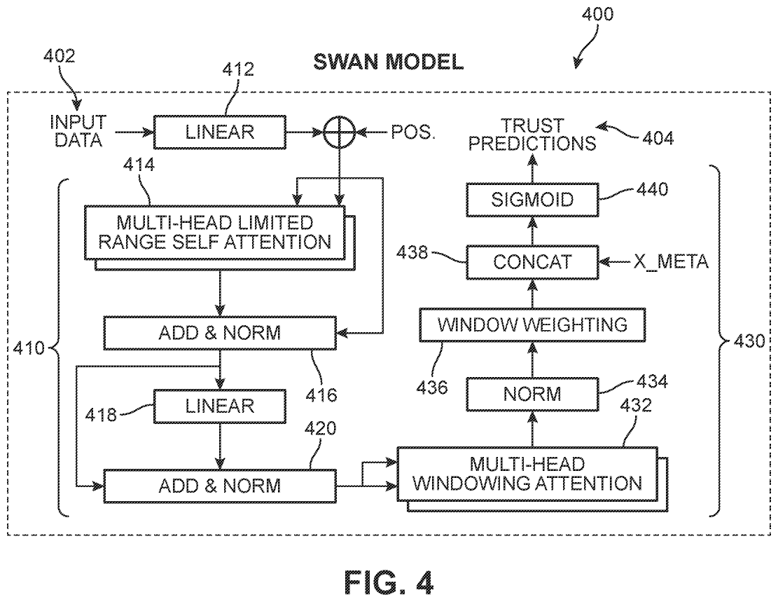

FIG. 4 is a schematic view of an exemplary architecture for SWAN model 400 (or simply “model 400”), according to one embodiment. Model 400 takes in input (“input data 402”) and provides an output (“trust predictions 404”).

In one embodiment, input data 402 is comprised of multiple streams of time series data across various modalities. In one embodiment, input data 402 includes vehicle data, user gaze signal data, and metadata. Vehicle data may be gathered from suitable vehicle sensors (for example, from sensors 250 of FIG. 2) and may comprise vehicle state data such as velocity, angular velocity, steering angle, navigation direction, engine sound volume, and on/off real-time proactive voice data. User gaze signal data may be gathered from suitable occupant sensors (such as from sensors 252 of FIG. 2) and may include x/y coordinates of a user's gaze on a screen (or windshield) as well as pupil diameters. In some cases, input data 402 may further include pre-processed information related to gaze signal data, such as a categorical feature to indicate the type of objects the gaze points falls on (such as pedestrians, roads, or trees). For example, a system may capture real-time images from a vehicle camera and correlate those images with gaze signals to determine an object in the images that a user is looking at. In some cases, the system may further use machine vision to identify and label the object, which may be used as part of input data 402.

In some embodiments, input data 402 may also include one or more streams of metadata, such as the observed mobility (car or sidewalk), driving style, and whether the autonomous driving system may provide proactive prompts.

Trust predictions 404, the model output, comprises trust values. As described above, trust values may be numerical or categorical, and may be binary or multi-valued. In one embodiment, the predicted values are binary and comprise a numerical or categorical value indicating a “low” trust and another indicating a “high” trust.

SWAN model 400 may include some features of a transformer neural network. Transformer neural networks are comprised of an encoder and a decoder and include both attention modules and neural network modules (such as feed forward networks). Transformers use attention mechanisms to map a query and a set of key-value pairs to an output. The final output is a weighting of the values (from the key-value pair), with the weights being computed according to the relationship of the query and a corresponding key.

In some cases, attention networks utilize a Scalar Dot-Product Attention mechanism, in which three matrices: Query (Q), Value (V), and Key (K) are used to computer weights for a matrix W. In particular, the weights for W may be calculated as a function of the Q and K matrices, while the attention output is calculated as a function of W with the value matrix V. The underlying idea of using an attention mechanism is to generate representations that focus on the parts of V that are most relevant to Q.

Input data 402 is processed by various modules of SWAN model 400. Model 400 is comprised of an encoder stack 410 and a decoder stack 430. Encoder stack 410 comprises a linear layer 412, a multi-head limited range self-attention module 414 (or “self-attention module 414”), a normalization layer 416, followed by another linear layer 418 and another normalization layer 420. Moreover, self-attention module 414 is further associated with a feed forward network that is not shown for simplicity.

Decoder stack 430 is comprised of a multi-head windowing attention module 432 (or simply “windowing attention module 432”), a norm layer 434, a Window Weighting module 436, a concatenation layer 438, and a sigmoid layer 440.

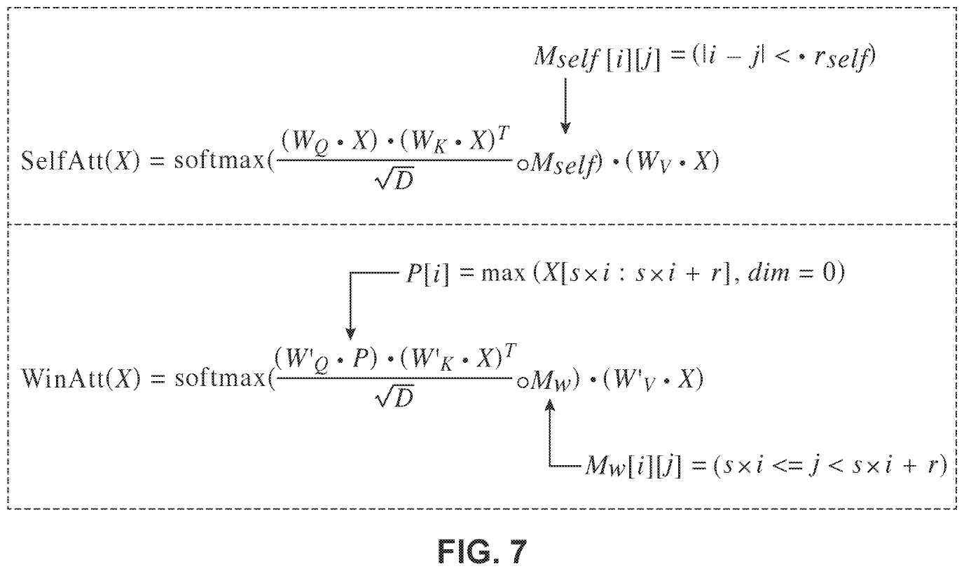

Self-Attention module 414 utilizes multiple attention heads for processing input data to efficiently learn the neighboring context of the input data. In other words, self-attention module 414 uses an attention mechanism to determine the relative importance of each time step in making predictions. Self-attention module 414 operates using Query (Q), Value (V), and Key (K) matrices associated with self-attention layers in a transformer to compute a matrix of weights W. The values of Q, V, and K are all determined by the input to the module (which input is itself a simple transformation of input data 402 to the entire network). The exemplary method assumes short time windows for trust alterations, so a range mask is applied to limit the attention of each signal step to its neighbors, with the self-attention range r_self being a hyper-parameter. Specifically, for an input with size L×D, where L is the padded sequence length and D is the feature dimension, the self-attention mask M_self is calculated and applied through element-wise multiplication on attention weights. The self-attention layer thereby applies each of the Q, V, and K weight matrices (that is, matrices W_{Q}, W_{V}, and W_{K}) to the module input and thereby transforms the input data into output data that may be provided to a corresponding feed forward network and then further processed according to the architecture. An explicit form of this transformation according to an embodiment, namely SelfAtt(X), is shown in FIG. 7.

Windowing attention module 432 uses multiple attention heads and divides signal steps into moving windows and embeds the salient information within each window. This is done by transforming the output from the self-attention layer from step sequences (L×D) to window sequences (Lw×D) through the use of dot-product attention with window masks and prompts. Given windowing range r and step s, a windowing attention mask, M_{w}(L_{w}×L) is given to indicate the moving window ranges. The module further defines window prompts, P, as a matrix of shape L_{w}×D and generates an attention matrix of shape L_{w}×L, indicating the attention weights assigned to each step by each window. The explicit form of this transformation according to an embodiment, namely WinAtt(X), is shown in FIG. 7.

Window weighting module 436 prioritizes critical windows by assigning higher weights to those critical windows. In particular, window weighting module 436 applies a softmax to each window so that the total sum is one. A transformation matrix W_{w} is used to infer window saliency from the embeddings and calculate a full sequence embedding as a weighted sum of window embeddings. The explicit form of this transformation is given as:

$$Output ( X ) = ( X \cdot {W}_{W} ) \cdot X$$

The exemplary network architecture provides a system that may learn from the long term and sparse datasets that are provided as inputs by focusing the network's attention on the most relevant time frames from the perspective of learning trust values.

One way of understanding how the exemplary SWAN model operates and differs from a simpler neural network architecture without attention, is to analyze the relevant attention weights at different points in time, as determining a final trust value (network output) will depend on these attention weights.

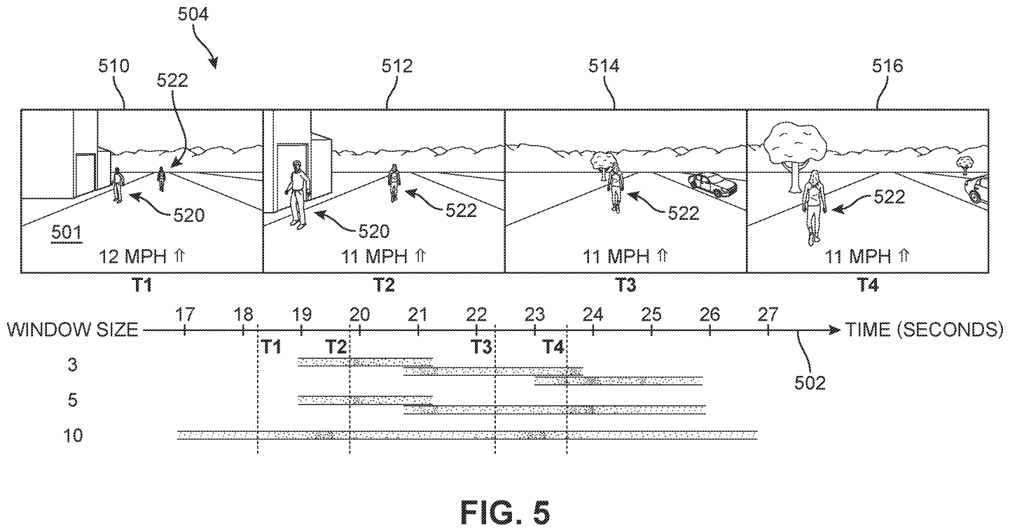

FIG. 5 is a schematic view of several images representing scenes from a driving sequence and corresponding window weightings visualized for the same time period. In this example, the scenes represent the view of the driver as a vehicle (not shown) traverses a roadway 501 with pedestrians walking alongside of the roadway.

Over a particular time period 502, a driver in an autonomous vehicle (such as a car or scooter) may view the mobility environment on a display, through a windshield, or directly. A series of scenes 504 that are viewed by the driver at select times (t1, t2, t3, and t4) are shown. In a first scene 510 associated with time t1, a first pedestrian 520 and a second pedestrian 522 are approaching from a significant distance. In a second scene 512 associated with time t2, first pedestrian 520 is passing beside the driver/vehicle. In a third scene 514 associated with time t3, second pedestrian 522 is still approaching at some significant distance. In a fourth scene 516 associated with time t4, second pedestrian 522 is passing beside the driver/vehicle.

The trust prediction system of the embodiments may capture real-time vehicle data and occupant data and predict real-time trust levels. For example, using suitable onboard sensors in a vehicle, the trust prediction system captures both relevant vehicle data (such as speed and steering angle) and relevant occupant data (such as gaze information) and processes the data in real time using a pre-trained SWAN model to predict trust levels.

A visualization of attention weights generated for an exemplary SWAN model over the same time period 502 are shown schematically beneath scenes 504. In particular, higher weights are indicated with darker shading. Moreover, the attention weights are shown for multiple different window sizes (3, 5, and 10), which will be discussed in further detail below.

As seen in FIG. 5, the trust prediction system determines that the greatest amount of attention (highest weights) should be paid to data during a period around time t2 and another period around time t4. In other words, the trust prediction system indicates that special attention should be paid to the data during times when the first or second pedestrian is passing beside the driver/vehicle. By contrast, the system determines that the least amount of attention (lowest weights) should be paid to the data during times when one or both pedestrians are further away. This weighting makes some intuitive sense, as the times when drivers may be most likely to change their trust levels towards automated driving systems are those times when there are objects nearby that may require complex maneuvering.

Moreover, while the highest weight periods differ slightly with different window sizes, there is substantial overlap and stability in the attention weights predicted by the system for these different sizes. In particular, the periods are all predicted to be approximately around the times t2 and t4, associated with the passing of a pedestrian.

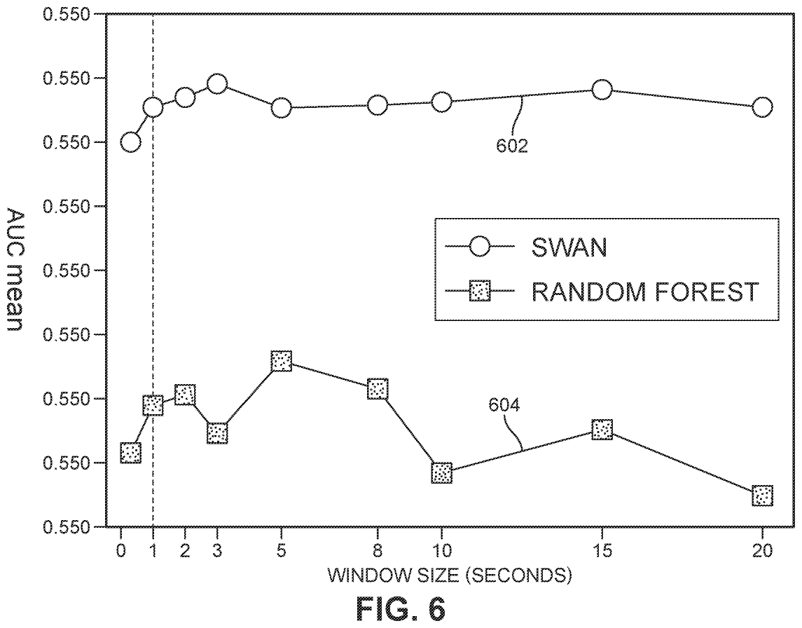

This robust prediction of window weights across different window sizes provides a significant improvement over existing techniques for predicting information from time series data and whose performance may vary substantially across window sizes. As an example, FIG. 6 shows a schematic plot of the performance of an SWAN model 602 and a Random Forest model 604 across different window sizes (measured in seconds). As seen in FIG. 6, SWAN model 602 is not as sensitive to window size as Random Forest model 604. This is indicative of the robustness of the exemplary SWAN model to predicting trust across different window sizes, thereby reducing the computational resources required to perform more intensive window selection searches, which must be done with other models (such as Random Forest model 604).

In addition to the stability of the model across window sizes, the exemplary architecture also provides a means of visualizing processes that are taking place within the network to facilitate better interpretations of the model, as already described above and shown in FIG. 5. By contrast, application of attention-less networks, such as convolutional neural networks (CNNs) and long short-term memory (LSTM) networks to similar time series data may provide less transparency into the network mechanisms and offer little for model interpretations.

The following includes definitions of selected terms employed herein. The definitions include various examples and/or forms of components that fall within the scope of a term and that may be used for implementation. The examples are not intended to be limiting. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system includes one or more processors. A “processor”, as used herein, generally processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

The apparatus and methods described herein and illustrated in the accompanying drawings by various blocks, modules, components, circuits, steps, processes, algorithms, etc. (collectively referred to as “elements”) may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

The processor may be connected to a communication infrastructure (e.g., a communications bus, cross-over bar, or network). Various software aspects are described in terms of this example computer system. After reading this description, it will become apparent to a person skilled in the relevant art(s) how to implement aspects described herein using other computer systems and/or architectures.

Computer system may include a display interface that forwards graphics, text, and other data from the communication infrastructure (or from a frame buffer) for display on a display unit. Display unit may include display, in one example. Computer system also includes a main memory, e.g., random access memory (RAM), and may also include a secondary memory. The secondary memory may include, e.g., a hard disk drive and/or a removable storage drive, representing a floppy disk drive, a magnetic tape drive, an optical disk drive, etc. The removable storage drive reads from and/or writes to a removable storage unit in a well-known manner. Removable storage unit, represents a floppy disk, magnetic tape, optical disk, etc., which is read by and written to removable storage drive. As will be appreciated, the removable storage unit includes a computer usable storage medium having stored therein computer software and/or data.

Computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data transferred via communications interface are in the form of signals, which may be electronic, electromagnetic, optical or other signals capable of being received by communications interface. These signals are provided to communications interface via a communications path (e.g., channel). This path carries signals and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals. These computer program products provide software to the computer system. Aspects described herein may be directed to such computer program products. Communications device may include communications interface.

Computer programs (also referred to as computer control logic) are stored in main memory and/or secondary memory. Computer programs may also be received via communications interface. Such computer programs, when executed, enable the computer system to perform various features in accordance with aspects described herein. In particular, the computer programs, when executed, enable the processor to perform such features. Accordingly, such computer programs represent controllers of the computer system.

In variations where aspects described herein are implemented using software, the software may be stored in a computer program product and loaded into computer system using removable storage drive, hard disk drive, or communications interface. The control logic (software), when executed by the processor, causes the processor to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s). In yet another example variation, aspects described herein are implemented using a combination of both hardware and software.

The foregoing disclosure of the preferred embodiments has been presented for purposes of illustration and description. It is not intended to be exhaustive or to limit the embodiments to the precise forms disclosed. Many variations and modifications of the embodiments described herein will be apparent to one of ordinary skill in the art in light of the above disclosure.

While various embodiments have been described, the description is intended to be exemplary, rather than limiting, and it will be apparent to those of ordinary skill in the art that many more embodiments and implementations are possible that are within the scope of the embodiments. Any feature of any embodiment may be used in combination with or substituted for any other feature or element in any other embodiment unless specifically restricted. Accordingly, the embodiments are not to be restricted except in light of the attached claims and their equivalents. Also, various modifications and changes may be made within the scope of the attached claims.

Further, in describing representative embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art may readily appreciate that the sequences may be varied and still remain within the spirit and scope of the present embodiments.

1. An autonomous driving agent for a vehicle, comprising:
circuitry coupled to one or more sensors of the vehicle, wherein the circuitry is configured to:
receive input data from the one or more sensors, the input data comprising occupant sensor data associated with an occupant of an autonomous vehicle and the input data comprising vehicle sensor data associated with the operation of the autonomous vehicle;
determine, from the input data, a trust value indicating a level of trust of a human in the autonomous driving agent using a neural network; and
automatically modify control of one or more vehicle systems of the vehicle according to the determined trust value.

2. The autonomous driving agent according to claim 1, wherein the vehicle is a self-driving vehicle and wherein the autonomous driving agent is configured to operate the self-driving vehicle based on a level of automation; and wherein the circuitry is configured to modify the level of automation according to the trust value.

3. The autonomous driving agent according to claim 1, wherein the circuitry is configured to generate and implement a human machine interface (HMI) action according to the trust value.

4. The autonomous driving agent according to claim 1, wherein the input data includes gaze information.

5. The autonomous driving agent according to claim 1, wherein the input data includes vehicle telemetry data.

6. The autonomous driving agent according to claim 1, wherein the neural network includes a limited-range self-attention module with a self-attention mechanism.

7. The autonomous driving agent according to claim 6, wherein the neural network includes a windowing attention module to transform step sequences that are provided as output of the limited-range self-attention module into window sequences.

8. The autonomous driving agent according to claim 7, wherein the neural network includes a window weighting module that assigns higher weights to some windows in the window sequences.

9. A system, comprising:
one or more processors;
memory storing instructions that when executed by the one or more processors cause the one or more processors to:
receive input data, the input data comprising occupant sensor data associated with an occupant of an autonomous vehicle and the input data comprising vehicle sensor data associated with the operation of the autonomous vehicle;
provide the input data to a neural network; and
generate a trust value using the neural network.

10. The system according to claim 9, wherein the instructions, when executed by the one or more processors, further cause the one or more processors to generate and implement a human machine interface (HMI) action or a driving automation action based on the trust value.

11. The system according to claim 9, wherein the neural network includes a limited-range self-attention module with a self-attention mechanism.

12. The system according to claim 11, wherein the neural network includes a windowing attention module to transform step sequences that are provided as output of the limited-range self-attention module into window sequences.

13. The system according to claim 12, wherein the neural network includes a window weighting module that assigns higher weights to some windows in the window sequences.

14. The system according to claim 9, further comprising a sensor for detecting gaze information for the occupant.

15. The system according to claim 9, further comprising a sensor for gathering vehicle telemetry information for the autonomous vehicle.

16. A computer-implemented method, comprising:
receiving input data, the input data comprising occupant sensor data associated with an occupant of an autonomous vehicle and the input data comprising vehicle sensor data associated with the operation of the autonomous vehicle;
providing the input data to a neural network; and
generating a trust value from the neural network.

17. The computer-implemented method according to claim 16, further comprising generating and implementing a human machine interface (HMI) action or a driving automation action based on the trust value.

18. The computer-implemented method according to claim 17, wherein implementing the HMI action includes highlighting an object on a display.

19. The computer-implemented method according to claim 17, wherein implementing the driving automation action includes decreasing autonomous control of the autonomous vehicle.

20. The computer-implemented method according to claim 17, wherein implementing the driving automation action includes increasing autonomous control of the autonomous vehicle.
